(19) United States
(12) Patent Application Publication
(10) Pub. No.: US 2017/0179630 A1
(43) Pub. Date: Jun. 22, 2017

(54) POWER CONNECTOR HAVING A DUAL-BEAM CONTACT

(71) Applicant: FOXCONN INTERCONNECT TECHNOLOGY LIMITED, Grand Cayman (KY)

(72) Inventor: CAI-YUAN WANG, HuaiAn (CN)

(21) Appl. No.: 15/386,309

(22) Filed: Dec. 21, 2016

(30) Foreign Application Priority Data
Dec. 21, 2015 (CN) 201521066914.4

(51) Int. Cl. H01R 13/24

(52) U.S. Cl. CPC H01R 13/2428

(57) ABSTRACT

A power connector includes: an insulative housing including an upper surface, a lower surface, and a receiving space; a number of contacts accommodated in the insulative housing each including a contacting portion, a rear portion accommodated in a rear end of the insulative housing, and a corrugated elastic portion connecting the contacting portion and the rear portion, the contacting portion including a lower tongue plate extending forwardly from the corrugated elastic portion, an upper tongue plate, and a curved section connecting the lower tongue plate and the upper tongue plate; wherein the curved section has a pair of contact beams.

### BACKGROUND OF THE INVENTION

### 1. Field of the Invention

The present invention relates to a battery or power connector contact, and more particularly to a contact having dual contact points.

### 2. Description of Related Arts

China Patent No. 204696297 (counterpart U.S. Patent Application Publication No. 2016/0315404), issued on Oct. 7, 2015, discloses a battery connector with contacts of a general construction the present invention relates to. Specifically, the disclosed contact has a bulging section to make single point contact with a battery. In large current applications, there exists risk of high temperature due to the single point contact. U.S. Pat. No. 4,773,877, issued on Sep. 27, 1988, discloses a varied contact head of a planar flat bar in an electronic tester contactor. The contact head is sawtoothed and acts to come into contact with a device to be tested.

### SUMMARY OF THE INVENTION

A power connector is provided to have dual contact beams in order to avoid temperature build-up in high current applications. The power connector comprises: an insulative housing comprising an upper surface, a lower surface, and a receiving space; and a plurality of contacts accommodated in the insulative housing, each of the plurality of contacts including a contacting portion, a rear portion accommodated in a rear end of the insulative housing, and a corrugated elastic portion connecting the contacting portion and the rear portion, the contacting portion comprising a lower tongue plate extending forwardly from the corrugated elastic portion, an upper tongue plate, and a curved section connecting the lower tongue plate and the upper tongue plate; wherein the curved section has a pair of contact beams.

### BRIEF DESCRIPTION OF THE DRAWING

FIG. 1 is a perspective view of a power connector in accordance with the present invention;

FIG. 2 is another perspective view of the power connector of FIG. 1 from an opposite perspective;

FIG. 3 is a perspective view of a contact of the power connector;

FIG. 4 is an exploded view of FIG. 1;

FIG. 5 is an exploded view of FIG. 2;

FIG. 6 is a cross-sectional view of an insulative housing of the power connector taken along line 6-6 in FIG. 4;

FIG. 7 is a cross-sectional view of the power connector along line 7-7 in FIG. 1;

FIG. 8 is a cross-sectional view of the power connector along line 8-8 in FIG. 1; and

FIG. 9 is a cross-sectional view of the power connector according to another embodiment of the invention.

### DETAILED DESCRIPTION OF THE PREFERRED EMBODIMENT

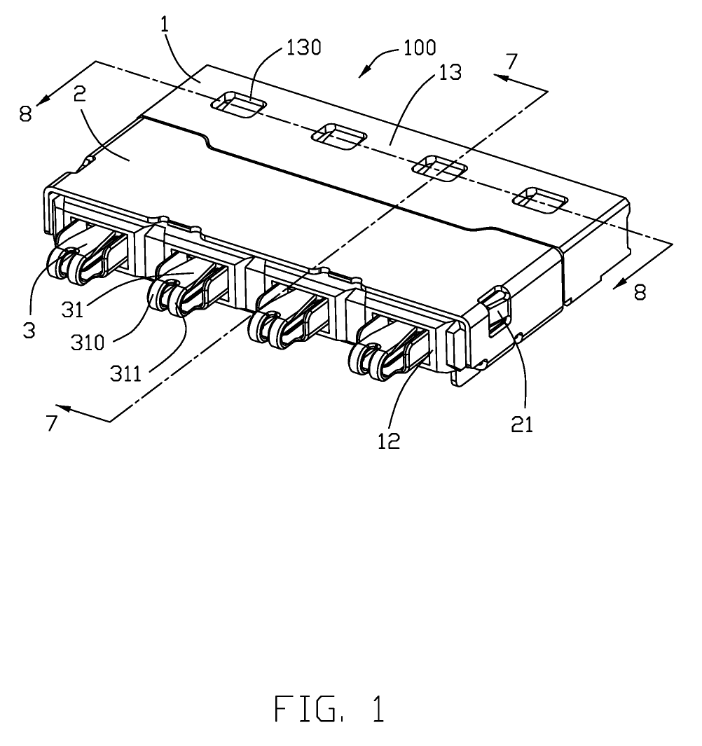

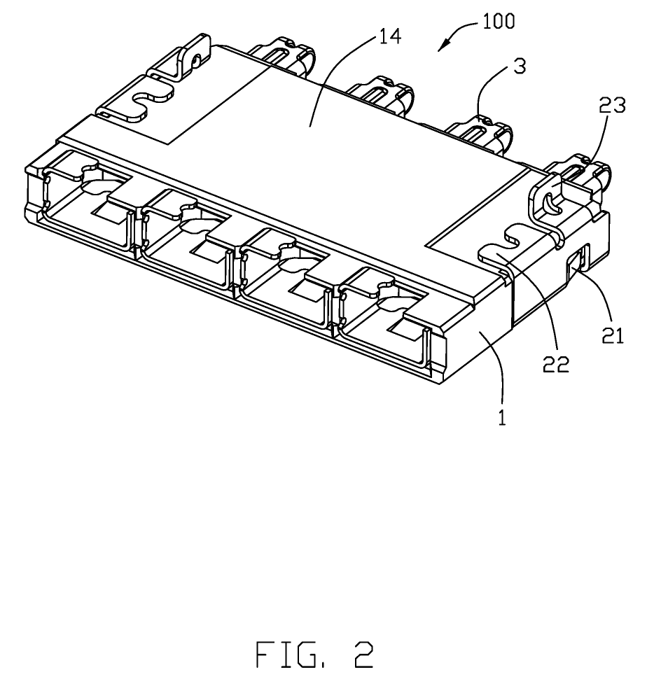

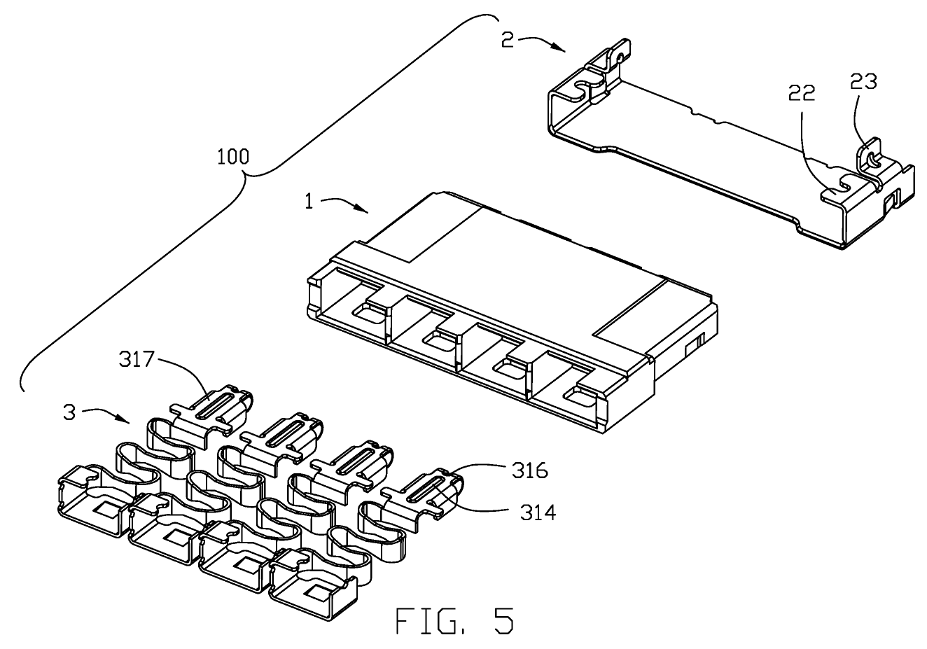

Referring to FIGS. 1 to 5, a power connector comprises an insulative housing 1, a plurality of contacts 3 respectively accommodated in the corresponding spaces/passageways 15 of the insulative housing 1, and a metallic shell 2 attached upon the housing 1.

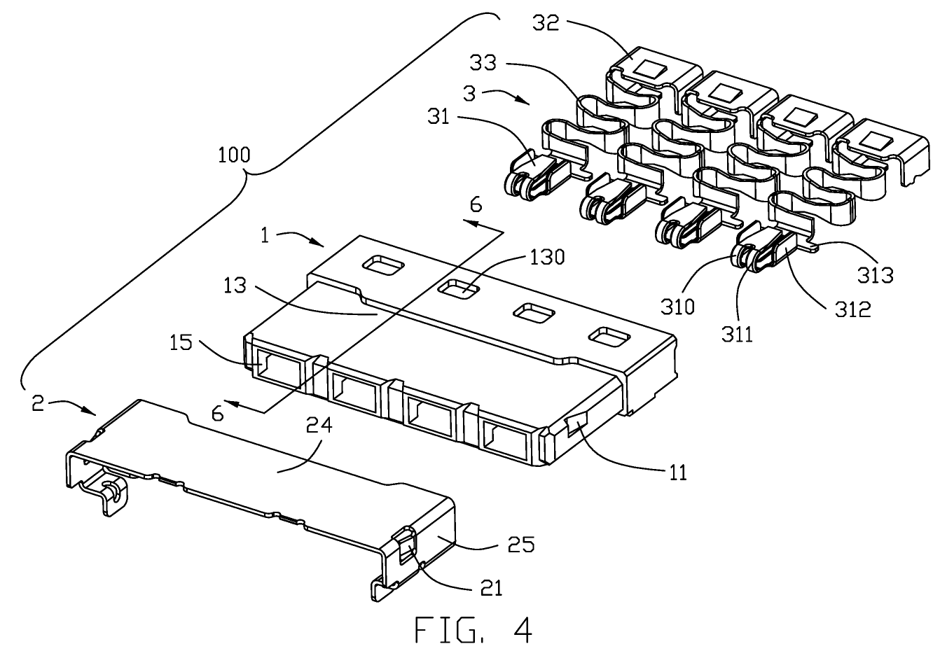

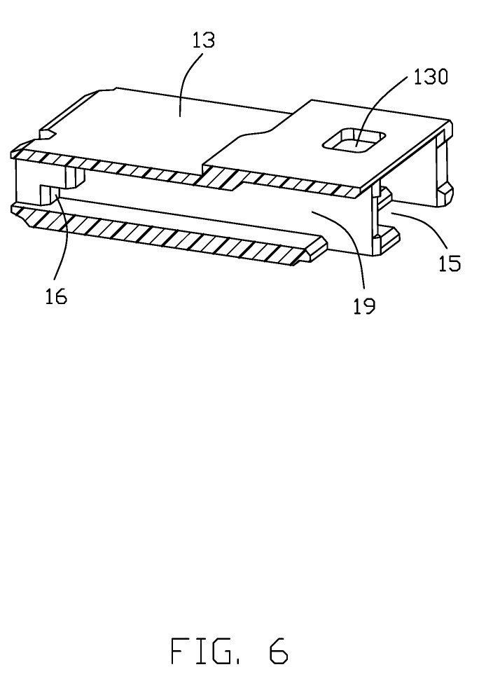

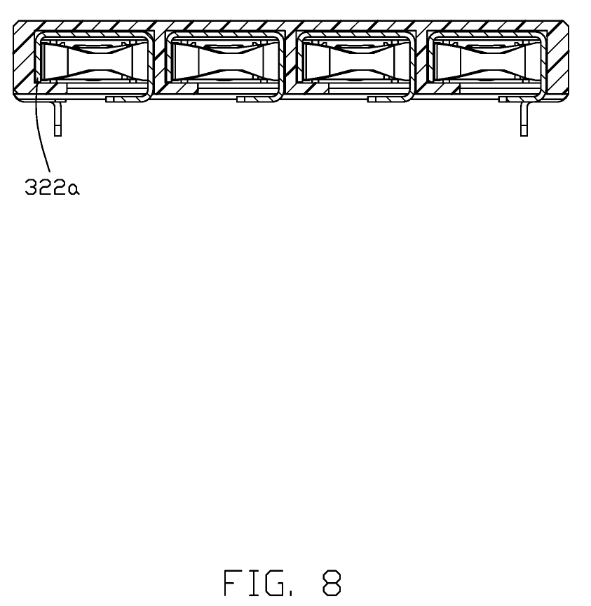

As shown in FIGS. 4 to 8, the insulative housing 1 comprises a pair of notches 11, a front surface 12, an upper surface 13, an opposite lower surface 14, a plurality of receiving spaces/passageways 15 separated from one another by the corresponding partitions 19, and a pair of steps/recesses 16 located by two sides of each space/passageway 15. The housing 1 further has a plurality of holes 130 through the upper surface 13.

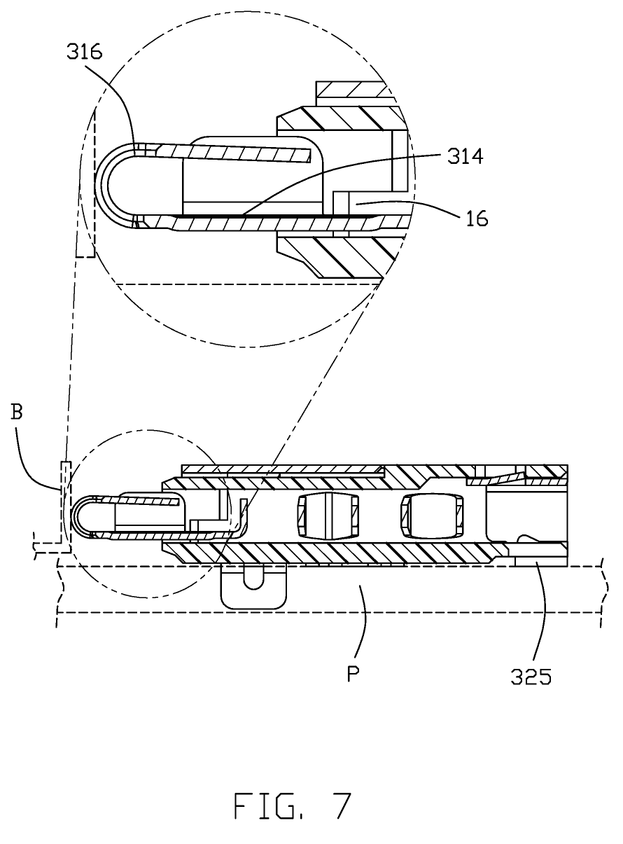

The shell 2 covers a front of the housing 1 and has a top wall 24, a pair of side walls 25 depending from the top wall, a pair of latches 21 on the side walls, a pair of securing tabs 22 extending from the corresponding side walls 25 parallel to the top wall 24 for holding the housing 1, and a pair of mounting legs 23 for mounting to a printed circuit board P (as shown in the broken lines in FIG. 7) on which the housing 1 is seated.

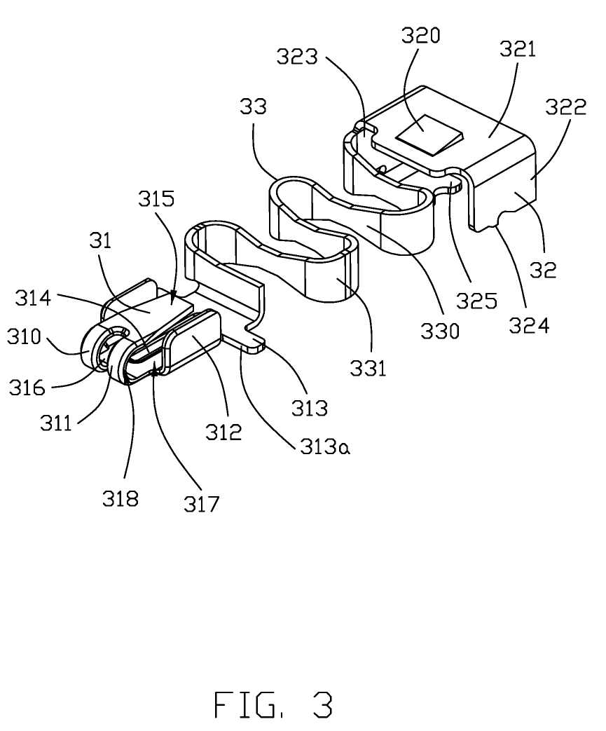

Referring to FIG. 3, the contact 3 comprises a front contacting portion 31 for contacting a mating connector, a rear portion 32 secured to the housing 1, and a corrugated/serpentine elastic/deformable portion 33 connecting the contacting portion 31 and the rear portion 32.

The contacting portion 31 extends out of the housing front surface 12 for mating with a planar art of the battery B (as shown in the broken lines in FIG. 7). The contacting portion 31 is generally U-shaped and includes a lower tongue (one) plate 317 extending forwardly from the corrugated elastic portion 33, an upper tongue (the other) plate 315, and a curved or bulged section 318 connecting the lower tongue plate 317 and the upper tongue plate 315. The curved section 318 has a pair of contact beams 310 and 311. A slot 316 extending the front-to-back direction, is formed between the pair of contact beams 310 and 311, in a transverse direction perpendicular to the front-to-back direction, with opposite two ends terminated at the corresponding upper tongue plate 315 and lower tongue plate 317 around similar positions in the front-to-back direction in a side view so as to have the pair of contact beams 310, 311 operated in a balanced manner. The lower tongue plate 317 has a pair of extension portions 312, a pair of arresting portions 313, and a strengthening ridge 314 wherein the lower tongue plate 317 cooperating with the pair of extension portions 312 commonly form an upstanding U-shaped structure. Notably, the ridge 314 extends rearwardly beyond the confrontation edge 313a of the arresting portion 313 so as to perform stable support upon the housing 1. In this embodiment, the lower tongue plate 317 essentially intimately confronts the housing 1 in the vertical direction perpendicular to both the front-to-back direction and the transverse direction for supporting consideration while the upper tongue plate 315 is essentially spaced from the housing in the vertical direction.

The rear portion 32 is positioned at a rear of the space 15 and has a holding ramp 320. The rear portion 32 essentially forms an upside-down U-shaped structure having a main base 321 on which the holding ramp 320 is located, and a pair of side plates 322, 323 downwardly extending from two opposite side edges of the main base 321 wherein the side plate 322 includes a barb structure 324 for engagement with the housing 1 while the other side plate 323 is equipped with a horizontal solder pad 325 for mounting to the printed circuit board P.

The elastic portion 33 is positioned inside the corresponding space 15 and includes one or more bent sections 331 and one or more connecting sections 330 each connected between two adjacent bent sections. A vertical dimension of the cross-section of the bent section 331 is greater than that of the connecting section 330.

In assembly, the contact 3 is inserted into the corresponding space 15 from a rear of the insulative housing 1, with the barb structure 324 engaged with the housing 1, the arresting portion 313 engaging the step 16 and the holding ramp 320 engaging the hole 130 of the housing 1. Under such an arrangement, the elastic portion 33 is in a tensioned/preloaded/compressed manner preferably.

The shell 2 is mounted onto the housing 1 with the latches 21 engaging the notches 11.

In use, with the provision of two contact beams 310 and 311, dual contact points can be achieved while avoiding temperature build-up in high current applications. It is also because the additional slot 316 is fully empty so that the generated heat due to electrical connection may efficiently escape via the slot 316.

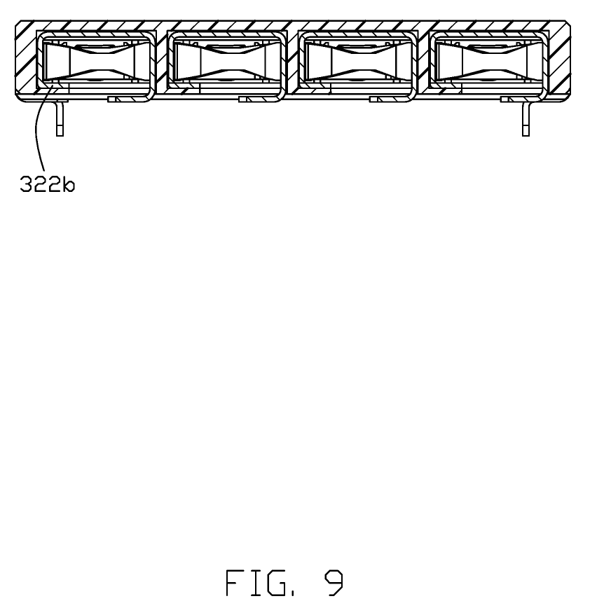

In the embodiment, the U-shaped rear portion 32 has the vertical side plate 322 engaged with the housing 1 via the barb structure 322a, the horizontal main base 321 engaged with the housing 1 via the cooperation of the holding ramp 320 and the hole 130, and another side plate 323 retained to the printed circuit board P via the solder pad 325. Anyhow, an alternate embodiment as shown in FIG. 9 may use a horizontal engaging plate 322b to replace the barb structure 322a for securely holding the rear portion 32 in position within the housing 1.

What is claimed is:

1. A power connector comprising:
an insulative housing comprising an upper surface, a lower surface, and a plurality of receiving spaces; and
a plurality of contacts respectively accommodated in the corresponding receiving spaces of the insulative housing, each of the plurality of contacts including a contacting portion, a rear portion accommodated in a rear end of the insulative housing, and a corrugated elastic portion connecting the contacting portion and the rear portion, the contacting portion comprising a lower tongue plate extending forwardly from the corrugated elastic portion, an upper tongue plate, and a curved section connecting the lower tongue plate and the upper tongue plate; wherein
the curved section has a pair of contact beams.

2. The power connector as recited in claim 1, wherein the curved section has a slot between the pair of contact beams.

3. The power connector as recited in claim 1, wherein the lower tongue plate comprises a pair of extension portions.

4. A power connector assembly comprising:
an insulative housing including a plurality of partitions to form corresponding passageways each extending along a front-to-back direction between two opposite front and rear ends of the housing; and
a plurality of contacts disposed in the corresponding passageway, each of said contact including a contacting portion forwardly extending out of the front end of the housing and back and forth movable along the front-to-back direction, an immovable rear portion fixed around the rear end of the housing, an deformable portion connected between the contacting portion and the rear portion in said front-to-back direction; wherein
said contacting portion includes, at a front end region, a forwardly facing bulged section, and said bulged section defines a slot extending along a front-to-back direction so as to form two parallel contact beams located by two sides of the slot in a transverse direction perpendicular to said front-to-back direction.

5. The power connector assembly as claimed in claim 4, wherein said slot includes two opposite ends terminated at similar positions along the front-to-back direction in a side view.

6. The power connector assembly as claimed in claim 4, wherein said contacting portion is essentially of a lying U-shaped structure including a lower tongue plate and an upper tongue plate with said bulged section connected therebetween, and one of said lower tongue plate and said upper tongue plate is supported by the housing in a vertical direction perpendicular to both the front-to-back direction and the transverse direction while the other is spaced from the housing in the vertical direction for free movement.

7. The power connector assembly as claimed in claim 6, wherein said one of said lower tongue plate and said upper tongue plate is connected to the deformable portion while the other of said lower tongue plate and said upper tongue plate has a rearwardly directing free end.

8. The power connector assembly as claimed in claim 7, wherein said one of said lower tongue plate and said upper tongue plate is equipped with a strengthening ridge extending along the front-to-back direction.

9. The power connector assembly as claimed in claim 8, wherein said strengthening ridge extends rearwardly beyond the slot in the front-to-back direction.

10. The power connector assembly as claimed in claim 7, wherein said one of the lower tongue plate and said upper tongue plate further includes a pair of arresting portions abutting against corresponding steps of the housing for preventing further forward movement of the contact.

11. The power connector assembly as claimed in claim 10, wherein said one of said lower tongue plate and said upper tongue plate is equipped with a strengthening ridge extending along the front-to-back direction, and said strengthening ridge extends is aligned with the slot in the front-to-back direction.

12. The power connector assembly as claimed in claim 11, wherein said strengthening ridge extends rearwardly beyond a forwardly facing confrontation edge of each of said arresting portions.

13. The power connector assembly as claimed in claim 7, wherein said one of the lower tongue plate and said upper tongue plate further includes a pair of extension portions to commonly form a U-shaped structure viewed along the front-to-back direction.

14. The power connector assembly as claimed in claim 4, wherein the rear portion forms an upside-down U-shaped structure including a horizontal main base with a holding ramp engaged within a hole for preventing rearward movement of the contact, a pair of side plates extending downwardly from two opposite side edges of the main base, one of said side plates equipped with an engaging structure for engagement with the housing while the other of said side plates being equipped with a horizontal solder pad.

15. The power connector assembly as claimed in claim 14, wherein said engaging structure is either a barb structure or an engaging plate.

16. The power connector assembly as claimed in claim 4, wherein said contacting portion is configured to be mated with a planar part of a battery in a head-to-head manner so as to have the slot fully empty during mating for heat transfer consideration.

17. A power connector comprising:
an insulative housing including a plurality of partitions to form corresponding passageways each extending along a front-to-back direction between two opposite front and rear ends of the housing; and
a plurality of contacts disposed in the corresponding passageway, each of said contact including a contacting portion forwardly extending out of the front end of the housing and back and forth movable along the front-to-back direction, an immovable rear portion fixed around the rear end of the housing, an deformable portion connected between the contacting portion and the rear portion in said front-to-back direction; wherein
the rear portion forms an upside-down U-shaped structure including a horizontal main base with a holding ramp engaged within a hole for preventing rearward movement of the contact, a pair of side plates extending downwardly from two opposite side edges of the main base in a vertical direction perpendicular to said front-to-back direction, one of said side plates equipped with an engaging structure for engagement with the housing while the other of said side plates being equipped with a horizontal solder pad.

18. The power connector as claimed in claim 17, wherein the contacting portion includes an upstanding U-shaped structure with a pair of upwardly extending extension portions for stabilizing the contacting portion, and further a pair of arresting portions behind said pair of upwardly extending extension portions for preventing further forward movement of the contact.

19. The power connector as claimed in claim 17, wherein said contacting portion defines two parallel contact beams isolated from each other via a slot therebetween in a transverse direction perpendicular to both said front-to-back direction and said vertical direction.

20. The power connector as claimed in claim 19, wherein the upstanding U-shaped structure further includes a strengthening ridge extending along the front-to-back direction in alignment with the slot.
